(19) United States
(12) Patent Application Publication
(10) Pub. No.: US 2011/0083123 A1
(43) Pub. Date: Apr. 7, 2011

(54) AUTOMATICALLY LOCALIZING ROOT ERROR THROUGH LOG ANALYSIS

(75) Inventors: Jian-Guang Lou, Beijing (CN); Qiang Fu, Beijing (CN); Jiang Li, Beijing (CN)

(73) Assignee: Microsoft Corporation, Redmond, WA (US)

(21) Appl. No.: 12/573,162

(22) Filed: Oct. 5, 2009

(51) Int. Cl. G06F 11/36; G06F 9/44; G06F 11/00

(52) U.S. Cl. 717/125; 714/E11.212; 714/38.1

(57) ABSTRACT

A computerized method for automatically locating a root error, the method includes receiving a first log having one or more log messages produced by one or more successful runs of a program, creating a finite state machine (FSM) from the first log of the program, the FSM representing an expected workflow of the program and creating a graph from the first log, the graph illustrating one or more dependencies between two or more components in the program. The method then includes receiving a second log produced by an unsuccessful run of the program, and determining, using a microprocessor, one or more root errors in the second log using the FSM and the graph.

### BACKGROUND

Traditionally, software developers print log messages when creating a program to track the runtime status of a system to help identify where problems may have occurred while the program is running. In order to identify where the problems may have occurred, the software developers must manually examine each of the log messages for a discrepancy. These log messages are usually unstructured free-form text messages, which are used to capture the system developers' intent and to record events or states of interest. In general, when a job fails, an experienced software development engineer or tester (SDE/SDET) examines recorded log files to gain insight about the failure and to identify the potential root causes of the failure. However, as many large scale and complex applications are deployed, which often contain complicated interaction between different components hosted by different machines, it becomes very time consuming for a SDE/SDET to diagnose system problems by manually examining a great amount of log messages. Furthermore, different components of a distributed system are usually developed by different groups or organizations, and a single developer may not have enough knowledge about all of the system components to accurately diagnose the system's problems. As a result, several SDEs/SDETs from different groups have to work together when investigating the problems. This situation introduces another type of complexity and often results in further delays in resolving the problem.

### SUMMARY

Described herein are implementations of various technologies for automatically localizing a root error in a program through log analysis. In one implementation, a computer application may be employed to automatically localize the root error in a program. As such, the computer application may first receive a training log produced by successful runs of the program. The computer application may examine the log messages in the training log and extract a log key and one or more parameters from each log message in the training log. The log key from each log message may indicate the meaning of the log message and the parameter may indicate an attribute of the log message. The sequence of the log messages in the training log may then be converted into log key sequences. The log key sequences may represent the work flow of the program.

If the log key sequence represents a single thread log key sequence, the computer application may systematically add states according to each transition in the log key sequence to create a finite state machine (FSM). If the log key sequence represents a multi-thread log key sequence, the computer application may first evaluate the temporal order of the log key sequence in order to create an initial FSM. Since multi-thread log key sequences include log keys that are interleaved with each other, the computer application may determine the temporal order relationship between each log key via a log item labeling process. The Log Item Labeling process may include a forward labeling process and a backward labeling process. These two labeling processes may determine a pair-wise temporal order or a relationship between adjacent log keys in the training log. The computer application may then create an initial FSM according to the temporal relationships between the log keys as determined by the forward labeling and the backward labeling processes. In one implementation, the computer application may employ a breadth-first search algorithm to determine the possible paths of the initial FSM by analyzing each log key pair. The breadth-first search algorithm may be used to determine which log key precedes the other. The breadth-first search algorithm may result in a set of log key paths that may be used to create the initial FSM for the multi-thread log key sequence. The computer application may then refine the initial FSM by verifying the initial FSM using the log key sequences listed in the training log. In one implementation, refining the FSM may include detecting loop structures and shortcuts within the training log that may not be represented in the initial FSM. After detecting these loop structures and shortcuts, the computer application may modify the initial FSM to include the detected loop structures and shortcuts.

The computer application may then determine how the log keys in the FSM may be interdependent on each other. In one implementation, the dependencies between log keys may often be used to locate a root error. In order to determine the inter-log key dependencies, the computer application may perform a co-occurrence observation, a correspondence observation and a delay time observation. The co-occurrence observation may determine whether the occurrence of one log key in the training log depends on the occurrence of another. For example, if log key B depends on log key A, then log key B is likely to occur within a short interval (dependency interval) after log key A occurred. The correspondence observation may determine whether two log keys as listed in the training log contain at least one identical parameter. In one implementation, the co-occurrence and the correspondence observations are evaluated by calculating a conditional probability between a pair of log keys listed in the training log. If the conditional probability of the pair of log keys exceeds a pre-determined threshold, the computer application may designate the pair of log keys as interdependent. As such, the co-occurrence and correspondence observations may be used to determine whether two log keys are dependent on each other. The computer application may also perform a delay time observation to determine whether a pair of log keys is dependent on each other. In one implementation, if the delay time between the pair of log keys is consistent, the pair of log keys may be determined to be interdependent. In contrast, inconsistent delay times may indicate that the pair of log keys is not interdependent. After identifying most of the interdependent log keys, the computer application may determine a dependency direction between the related log key pair using a Bayesian decision theory algorithm. The computer application may then create a dependency graph (DG) using the interdependent log key pairs and their corresponding dependency directions. In one implementation, the DG may illustrate how program components or log keys are interdependent.

After creating the FSMs (i.e., one FSM for each system component) and the DG using the training log, the computer application may then obtain a new log created by a newly executed job. In one implementation, the computer application may use the FSM to determine whether there is an anomaly in the new log as compared to the training log. In one implementation, the computer application may try to generate each log sequence listed in the new log using the FSM. Upon determining that a log sequence cannot be generated in the FSM, the computer application may determine that the log sequence contains an error position. The error position may be described as the first log message that cannot be produced by FSM. The computer application may be used to identify the error positions for all the program components using their corresponding logs and the FSMs. The computer application may then determine whether the error positions from different components are related using the following two rules. The first rule is to identify related error positions when the time difference between the occurrences of two error positions is less than a predetermined threshold. The second rule is to identify related error positions when there is a dependency between two inaccessible states of the two errors. Inaccessible states may refer to state transitions in the new log that cannot occur according to the FSM. The computer application may then use the DG to determine the dependencies of the identified error positions and locate the root error of the related errors and an error propagation path among the program components.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic diagram of a computing system in which the various techniques described herein may be incorporated and practiced.

FIG. 2 illustrates a flow diagram of a method for automatically localizing a root error in a program through log analysis in accordance with one or more implementations of various techniques described herein.

FIG. 3 illustrates a flow diagram of a method for creating a finite state machine in accordance with one or more implementations of various techniques described herein.

FIG. 4A illustrates an example of a simple finite state machine in accordance with one or more implementations of various techniques described herein.

FIG. 4B illustrates an example of samples of 2-thread interleaving logs in accordance with one or more implementations of various techniques described herein.

FIG. 5 illustrates an example of forward and backward labeling in accordance with one or more implementations of various techniques described herein.

FIG. 6 illustrates an example of temporal relationships between log keys in accordance with one or more implementations of various techniques described herein.

FIG. 7 illustrates an example of a pruning strategy for a FSM using a breadth-first search algorithm in accordance with one or more implementations of various techniques described herein.

FIG. 8 illustrates an example of a finite state machine verification process in accordance with one or more implementations of various techniques described herein.

FIG. 9 illustrates a flow diagram of a method for creating a dependency graph in accordance with one or more implementations of various techniques described herein.

FIG. 10 illustrates an example of redundant dependencies in accordance with one or more implementations of various techniques described herein.

FIG. 11 illustrates a flow diagram of a method for determining a root error in accordance with one or more implementations of various techniques described herein.

FIG. 12 illustrates an example of FSMs with branches in accordance with one or more implementations of various techniques described herein.

### DETAILED DESCRIPTION

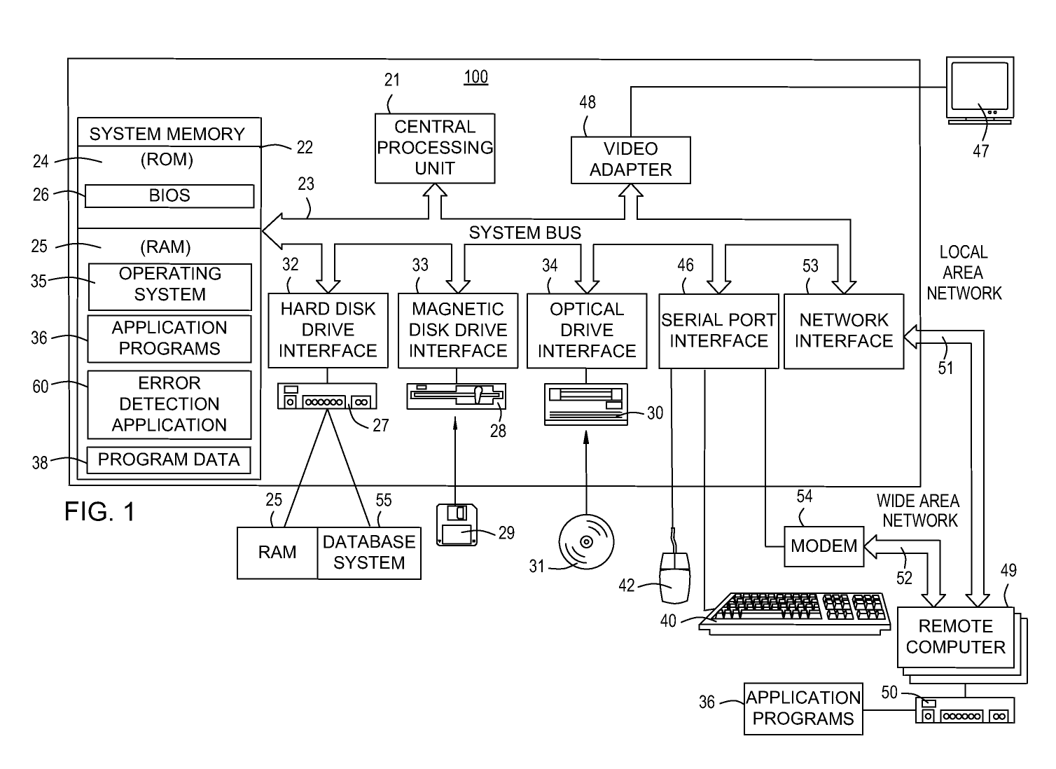

In general, one or more implementations described herein are directed to automatically localizing a root error in a program through log analysis. Various techniques for automatically localizing a root error in a program through log analysis will be described in more detail with reference to FIGS. 1-12.

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc. that performs particular tasks or implement particular abstract data types. The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

FIG. 1 illustrates a schematic diagram of a computing system 100 in which the various technologies described herein may be incorporated and practiced. Although the computing system 100 may be a conventional desktop or a server computer, as described above, other computer system configurations may be used.

The computing system 100 may include a central processing unit (CPU) 21, a system memory 22 and a system bus 23 that couples various system components including the system memory 22 to the CPU 21. Although only one CPU is illustrated in FIG. 1, it should be understood that in some implementations the computing system 100 may include more than one CPU. The system bus 23 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 22 may include a read only memory (ROM) 24 and a random access memory (RAM) 25. A basic input/output system (BIOS) 26, containing the basic routines that help transfer information between elements within the computing system 100, such as during start-up, may be stored in the ROM 24.

The computing system 100 may further include a hard disk drive 27 for reading from and writing to a hard disk, a magnetic disk drive 28 for reading from and writing to a removable magnetic disk 29, and an optical disk drive 30 for reading from and writing to a removable optical disk 31, such as a CD ROM or other optical media. The hard disk drive 27, the magnetic disk drive 28, and the optical disk drive 30 may be connected to the system bus 23 by a hard disk drive interface 32, a magnetic disk drive interface 33, and an optical drive interface 34, respectively. The drives and their associated computer-readable media may provide nonvolatile storage of computer-readable instructions, data structures, program modules and other data for the computing system 100.

Although the computing system 100 is described herein as having a hard disk, a removable magnetic disk 29 and a removable optical disk 31, it should be appreciated by those skilled in the art that the computing system 100 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 100. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. Combinations of any of the above may also be included within the scope of computer readable media.

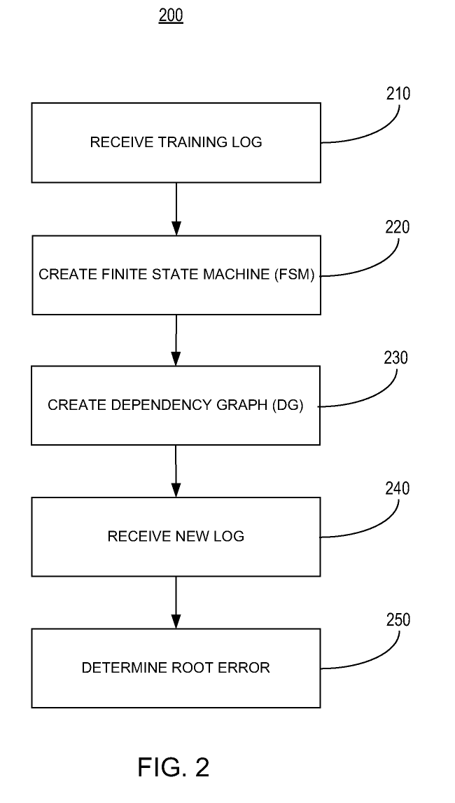

A number of program modules may be stored on the hard disk 27, magnetic disk 29, optical disk 31, ROM 24 or RAM 25, including an operating system 35, one or more application programs 36, an error detection application 60, program data 38, and a database system 55. The operating system 35 may be any suitable operating system that may control the operation of a networked personal or server computer, such as Windows® XP, Mac OS® X, Unix-variants (e.g., Linux® and BSD®), and the like. The error detection application 60 will be described in more detail with reference to FIGS. 2-12 in the paragraphs below.

A user may enter commands and information into the computing system 100 through input devices such as a keyboard 40 and pointing device 42. Other input devices may include a microphone, joystick, game pad, satellite dish, scanner, or the like. These and other input devices may be connected to the CPU 21 through a serial port interface 46 coupled to system bus 23, but may be connected by other interfaces, such as a parallel port, game port or a universal serial bus (USB). A monitor 47 or other type of display device may also be connected to system bus 23 via an interface, such as a video adapter 48. In addition to the monitor 47, the computing system 100 may further include other peripheral output devices such as speakers and printers.

Further, the computing system 100 may operate in a networked environment using logical connections to one or more remote computers 49. The logical connections may be any connection that is commonplace in offices, enterprise-wide computer networks, intranets, and the Internet, such as local area network (LAN) 51 and a wide area network (WAN) 52.

When using a LAN networking environment, the computing system 100 may be connected to the local network 51 through a network interface or adapter 53. When used in a WAN networking environment, the computing system 100 may include a modem 54, wireless router or other means for establishing communication over a wide area network 52, such as the Internet. The modem 54, which may be internal or external, may be connected to the system bus 23 via the serial port interface 46. In a networked environment, program modules depicted relative to the computing system 100, or portions thereof, may be stored in a remote memory storage device 50. It will be appreciated that the network connections shown are exemplary and other means of establishing a communications link between the computers may be used.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device. One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

FIG. 2 illustrates a flow diagram of a method for automatically localizing a root error in a program through log analysis in accordance with one or more implementations of various techniques described herein. The following description of flow diagram 200 is made with reference to computing system 100 of FIG. 1. It should be understood that while the operational flow diagram 200 indicates a particular order of execution of the operations, in some implementations, certain portions of the operations might be executed in a different order. In one implementation, the method for automatically localizing a root error in a program through log analysis may be performed by the error detection application 60.

At step 210, the error detection application 60 may receive a training log. The training log may include log messages describing the run-time behavior of a program. The run-time behavior may include events, states and inter-component interactions. In one implementation, the log messages may be unstructured text consisting of two types of information: (1) a free-form text string used to describe the semantic meaning of the behavior of a program; and (2) parameters used to express some important system attributes. For example, each of the log messages printed by the log print statement: “fprintf(Logfile, “the Job id %d is starting!\n”, JobID);” consists of an invariant text string part (“the Job id is starting!”) and a parameter part (“JobID”) that may have different values.

At step 220, the error detection application 60 may create a finite state machine (FSM) using the log messages in the training log received at step 210. The FSM is a model of the program's behavior composed of a finite number of states, transitions between the states, and actions. The FSM may describe the control logic and work flow of the program or any other software application. As a program model, the FSM may be used in testing and debugging programs because many program errors are related to abnormal execution paths. Additionally, the FSM may also be used to model the work flow of each component in a distributed system and to detect execution errors in the distributed system. In one implementation, the FSM may be defined as a quintuple (Σ, S, s₀, δ, F), where Σ is the set of log keys, S is a finite, non-empty set of states, s₀ is an initial state (i.e., where all program threads start) and also an element of S, δ is the state-transition function that represents the transition from one state to another state under the condition of input log key, δ:S×Σ→S, and F is the set of final states which is a subset of S. A special element θεΣ represents a null log key. Also δ(q₁,θ)=q₂ may signify that state q₁ can transit to state q₂ without any input log key. In one implementation, the program may include threads such that each thread may correspond to a specific work flow. The threads may be basic application execution units. Each thread's logs may contain the thread's identification (ID) information which can be used to distinguish the logs produced by different threads in the program.

In one implementation, the training log received at step 210 may be produced by a single thread. As such, the error detection application 60 may construct an FSM from the sequential log key sequences listed in the training log using a sequential trace analysis algorithm. In this manner, the error detection application 60 may first denote the current FSM as fsm, the current state as qεS, the current input log key as l, and the input sequence of log keys as L. At a first step (step 1), the error detection application 60 may set fsm equal to an initial FSM that only contains the initial state s₀, q=s₀, and input log key l is the first log key in input sequence of log keys L.

At a second step (step 2), the error detection application 60 may check whether a sub-sequence of the input log keys starting from the current input log key l can be generated by a submachine of fsm, and whether the length of the sub-sequence is not less than k. Here, k is a parameter of the algorithm which will be discussed in the paragraphs below. If such a sub-sequence does not exist, the error detection application 60 may proceed to step 3 where the error detection application 60 may add a new state q_{new} to S, a new transition δ(q,l)=q_{new} and at the same time, the error detection application 60 may update the current input log key l by its succeeding log key.

Otherwise, if current state q≠q′ where q′ is the starting state of the submachine, the error detection application 60 may proceed to step 4 where the error detection application 60 may add a new transition δ(q,θ)=q′. After adding the new transition δ(q,θ)=q′, the error detection application 60 may update the current input log key l by the succeeding log key of the sub-sequence in input sequence of log keys L, and update the current state q by the final state of the found submachine.

The error detection application 60 may then proceed to step 5, which may include looping back to step 2 until the error detection application 60 reaches the end of input sequence of log keys L. In the above algorithm, the parameter k identifies the shortest sub-sequence of the log keys that corresponds to a meaningful behavior pattern of the observed system component (i.e., a state in FSM). With different values of k, the error detection application 60 may construct different FSMs. When k=len(L), the whole log key sequence L becomes a sequential FSM without any branch or loop structure, i.e., the FSM has a zero generalization capability. As such, the FSM may predict some behaviors that are not explicitly described in the training log. Conversely, when k=1, each input log key uniquely defines a state transition and the FSM introduces maximum generalization capabilities. Additionally, the above described algorithm may be an incremental FSM that can consume and eliminate the log messages incrementally.

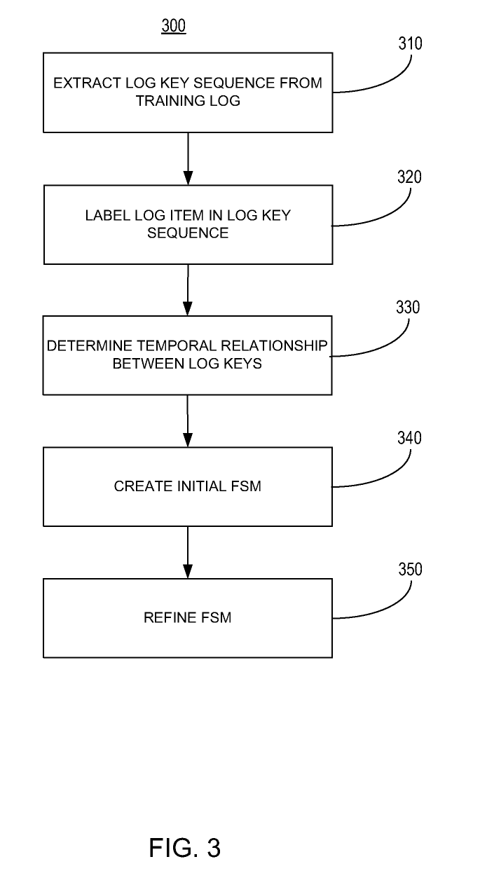

In another implementation, the error detection application 60 may analyze each thread and create a FSM to handle multiple thread programs. The method for creating an FSM based on multiple thread programs will be described in more detail in the paragraphs below with reference to FIG. 3.

At step 230, the error detection application 60 may create a dependency graph (DG). In many distributed systems, the system components may be distributed at different hosts which are often highly dependent on each other. As such, an error occurring at one component often causes execution anomalies in other components due to this inter-component dependency. The DG may be used to determine the inter-component dependencies such that the root error may be located from a set of related errors.

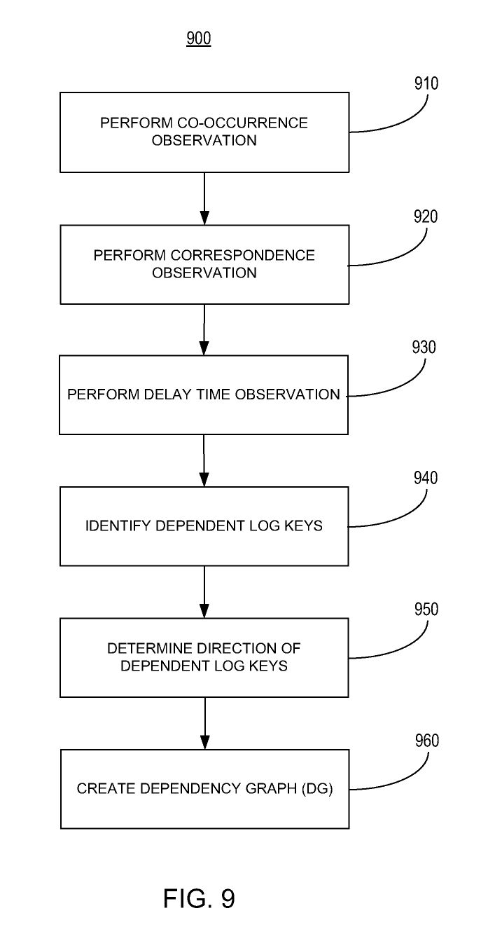

In one implementation, the error detection application 60 may identify the dependency between two cross component states by leveraging an observation such that if a particular state (state B) depends on another state (state A), then state B is likely to occur within a short interval (e.g., dependency interval) after state A's occurrence. However, since some state pairs of state A and state B may be hosted by different machines, the temporal order of state A and state B may not be correctly observed because the time stamps of the different machines may not be precisely synchronized. In order to overcome the possible temporal disorder of state pairs, the error detection application 60 may derive the inter-component dependencies by determining the probabilities of each state's occurrence without considering the temporal orders and then by determining a dependency direction for each related state pair based on Bayesian decision theory. The error detection application 60 may then construct the DG according to the identified inter-component dependencies and dependency directions. The method for constructing the DG will be described in greater detail in the paragraphs below with respect to FIG. 9.

At step 240, the error detection application 60 may receive a new log. The new log may be obtained after running the program, described at step 210, under a different input data or a different execution environment. The new job may not be running successfully like the jobs that produced the training log. In this manner, the new log may contain important details describing why the new job is no longer running successfully.

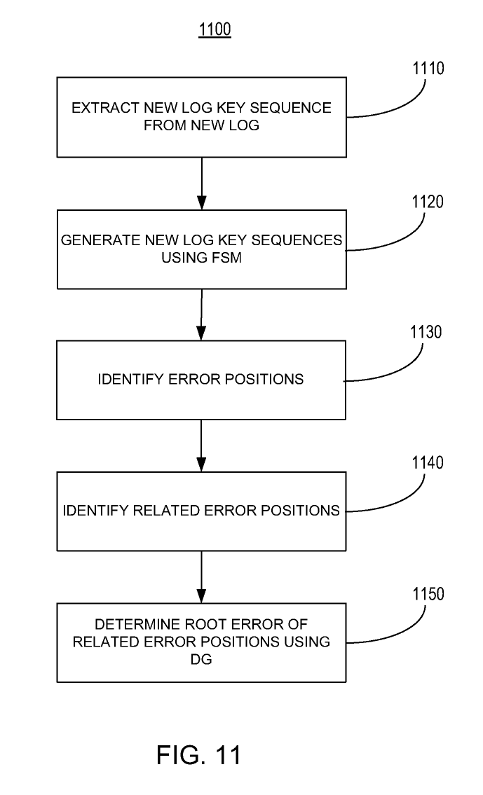

At step 250, the error detection application 60 may use the FSM and the DG to determine the root error of the new log. In one implementation, the error detection application 60 may extract a new log sequence from the new log and determine whether the new log sequence of a component is acceptable according to the FSM. If the new log sequence can be generated by the FSM, then the error detection application 60 may determine that there is no anomaly in the new log and the new log does not contain any errors. However, if only a part of the new log sequence (e.g., from the starting point to a particular state q) can be generated by the FSM, the error detection application 60 may designate the new log key sequence as abnormal. In one implementation, the abnormal log key sequence may be considered to be an error in the execution of the new job. The first log item that cannot be generated by the FSM may be identified as an error position in the new job. The error detection application 60 may then use the DG to determine the root error of the new log. In one implementation, the error detection application 60 may determine a root error for all system components independently and simultaneously. The method for determining the root error will be described in greater detail in the paragraphs below with respect to FIG. 11.

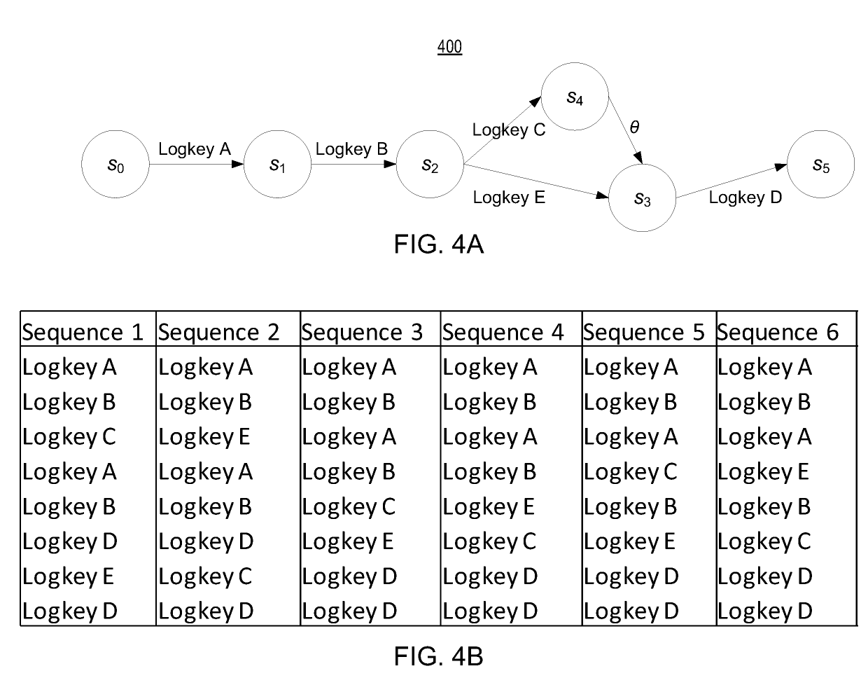

FIG. 3 illustrates a flow diagram of a method for creating a finite state machine in accordance with one or more implementations of various techniques described herein. The following description of flow diagram 300 is made with reference to computing system 100 of FIG. 1, the flow diagram 200 of FIG. 2 and the examples illustrated in FIGS. 4-8. It should be understood that while the operational flow diagram 300 indicates a particular order of execution of the operations, in some implementations, certain portions of the operations might be executed in a different order. In one implementation, the method for creating the finite state machine may be performed by the error detection application 60.

In one implementation, some applications do not write a thread identification (ID) on the log key messages, and the log messages of different threads are interweaved (multi-thread). Therefore, the error detection application 60 may design a FSM that can handle the multi-thread issues with log messages that do not contain thread IDs. Multiple threads running with the same state machine can produce different log item sequences under different interleaving patterns. This may be caused by thread switching under different work load profiles, background resource usages, or some random arrival of events. For example, FIG. 4A illustrates a sample FSM in which each circle is a state and a transition between two states is associated with an input log key. FIG. 4B shows six sample log sequences that can be produced by two threads running in the state machine depicted in FIG. 4A. Because of the complex interleaving of the log key sequence, creating the FSM from multi-thread log key sequences is much more difficult than that of a single-thread log key sequence. The method described in FIG. 3 creates a FSM from log sequences generated by a multi-thread application without thread IDs. The method of FIG. 3 may be based on the assumption that multiple threads running a single component often follow the same FSM. This assumption is reasonable because many software applications are developed using modularization or object-oriented technology. The method of FIG. 3 may also be based on the assumption that the training log data contains as many multi-thread interleaving patterns as possible.

The algorithm detailed in FIG. 3 generally consists of the following steps. First, the error detection application 60 may identify temporal order relationships among log keys through labeling the log items both in the forward direction and the backward direction. Then, according to the obtained temporal relationships, the error detection application 60 may create an initial FSM for each system component using a breadth-first search algorithm. Finally, the error detection application 60 may refine the FSM by verifying it with the log key sequences in the training log. Similar to the sequential trace analysis algorithm as described earlier, the error detection application 60 may use a multi-thread trace analysis algorithm to determine a state in the FSM because multiple consecutive log messages may belong to different threads. FIG. 3 will now be described in more detail in the following paragraphs.

At step 310, the error detection application 60 may extract a log key sequence from the training log received at step 210. In one implementation, the error detection application 60 may denote the text string of each log message in the training log as a log key. The error detection application 60 may extract log keys automatically from the log messages by removing parameters from the log messages. In some implementations, the parameters of the log messages may follow a symbol such as “:” (or “=”); may be embraced by symbols such as “{ }”, “[ ]” or “( )”; or may be displayed in a number format; or may be in a Uniform Resource Identifier (URI) format. In one implementation, the error detection application 60 may receive a set of empirical expression rules to remove the parameter from the log messages. The set of empirical expression rules may define where the parameters in the log messages are stored. The error detection application 60 may employ a user interface to allow users to define these rules. The pre-defined empirical rules may be based on some typical cases to define the parameters of the log messages.

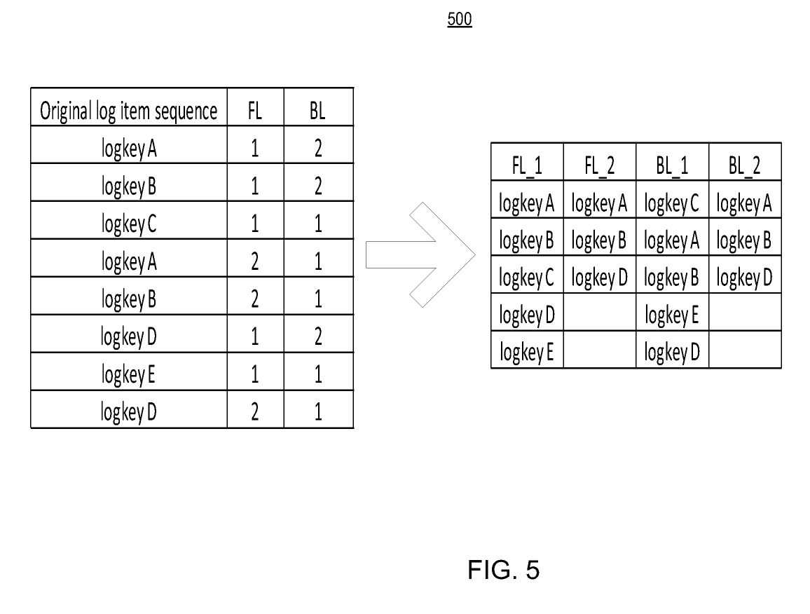

At step 320, the error detection application 60 may label each log item in the log key sequence. In one implementation, in order to cope with the interleaved log items, the error detection application 60 may employ two labeling operations: forward labeling (FL) and backward labeling (BL). These labeling operations may be used to find the temporal order relationships among the log keys. For instance, FL may assign each log item with the number of times that the same log key has appeared from the first log item to the current item in the forward direction of the log key sequence. BL may also assign a number to each log item. However, the number in BL is counted in the backward direction. The left part of FIG. 5 illustrates an example of the labeling processes including FL and BL. According to FIG. 5, the item “logkey A” in the second row is labeled as 1 (FL=1) because it is the first appearance of “logkey A” during the forward labeling or in the forward direction. The item “logkey A” in the fifth row is labeled as 2 (FL=2) because this is the second appearance of “logkey A.” Based on the FL and BL, the error detection application 60 may further group the original log key sequences into a set of sub-sequences, as shown on the right part of FIG. 5. For example, the error detection application 60 may group log items with the label of FL=1 into one single sub-sequence.

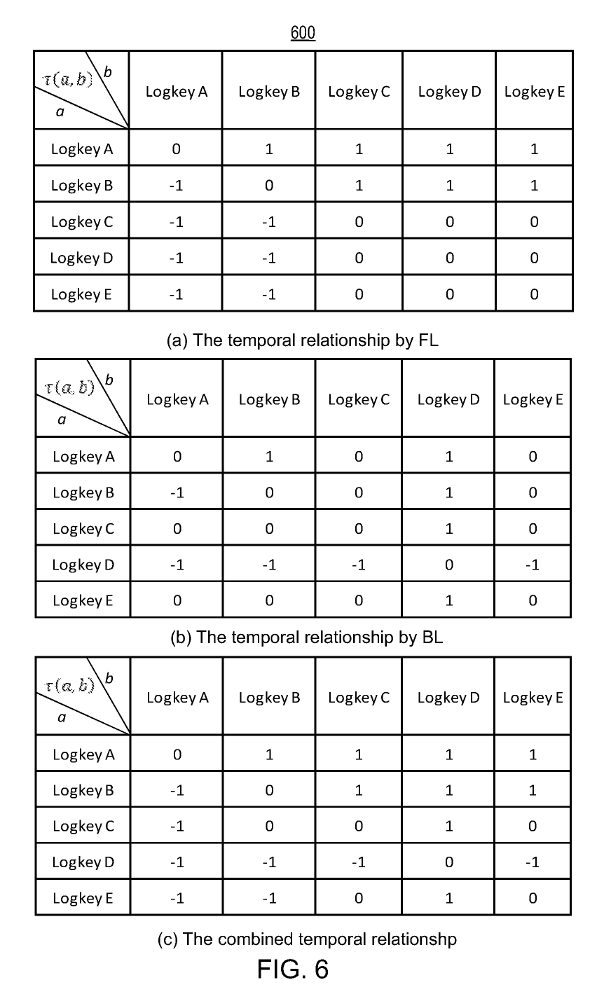

At step 330, the error detection application 60 may determine the temporal relationships between the log keys using the log item labels described in step 320. In one implementation, the error detection application 60 may check all of the FL sub-sequences for each pair of log keys. If log key a always occurs before log key b in all FL sub-sequences, the error detection application 60 may set temporal relationship τ(a,b)=1 and temporal relationship τ(b,a)=−1. Otherwise, the error detection application 60 may set temporal relationship τ(a,b)=0 and temporal relationship τ(b,a)=0. In one implementation, the identified temporal relationships from the examples illustrated in FIGS. 4A, 4B and 5 are shown in FIG. 6(a) such that “1” indicates that that the corresponding log key occurs after the occurrence of another log key and “−1” indicates that the corresponding log key occurs before the occurrence of another log key.

In one implementation, due to the complex interleaving of multiple threads, the temporal relationships between the log keys located on a branch of the FSM (e.g., Logkey C and Logkey E in FIG. 4A) and the log keys after the convergence state of the branch (e.g., Logkey D) cannot be determined exactly from the FL sub-sequences. Fortunately, the error detection application 60 may identify these temporal relationships based on the BL sub-sequences as illustrated in FIG. 6(b). In fact, FL and BL are two complementary operations for learning temporal relationships before and after branched log keys. Therefore, by combining with FL and BL operations, the error detection application 60 may obtain the temporal relationships among log keys. The error detection application 60 may then merge the temporal order relationships from FL and BL as shown in FIG. 6(c).

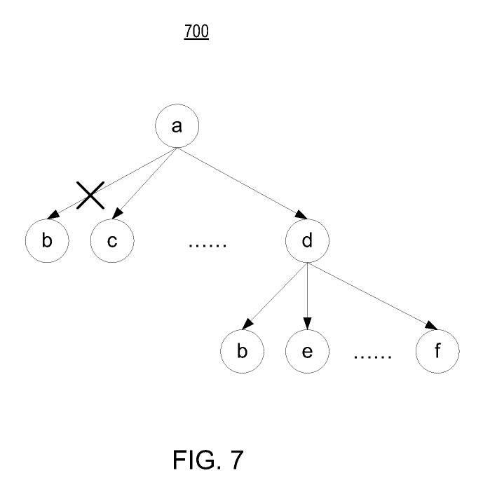

At step 340, the error detection application 60 may create an initial FSM based on the temporal relationships between the log keys as determined in step 330. In one implementation, the error detection application 60 may use a breadth-first search algorithm to identify the possible paths of the FSM based on the identified temporal relationship. The breadth-first search algorithm may examine each log key pair (a,b) and determine whether the log key pair satisfies τ(a,b)=1. If the log key pair (a,b) satisfies the τ(a,b)=1 condition, the error detection application 60 may denote b as a's successor, and a as b's predecessor. The breadth-first search algorithm may start from the log keys that do not have a preceding log key. In one implementation, the obtained paths may be stored in a tree-like data structure. In order to reduce the ambiguity and complexity of the tree-like data structure, the error detection application 60 may use a pruning strategy during the search process. The pruning strategy may keep longer paths and remove shorter paths, so as to give the most compact expression of the temporal order relationship. For example, in FIG. 7, the branch from log key a to log key b is pruned because the length of the path a→d→b is larger than that of the path a→b. Additionally, the path a→d→b can explain the temporal order expressed by the path a→b. In some implementations, short paths may include false positive paths that are not essential to the explanation of the obtained temporal order. Therefore, the pruning strategy can help remove some of these potential false positive paths. However, some real short paths (e.g., shortcuts) may also be pruned using this pruning strategy. The error detection application 60 may try to recover these real short paths during a verification process described in step 350.

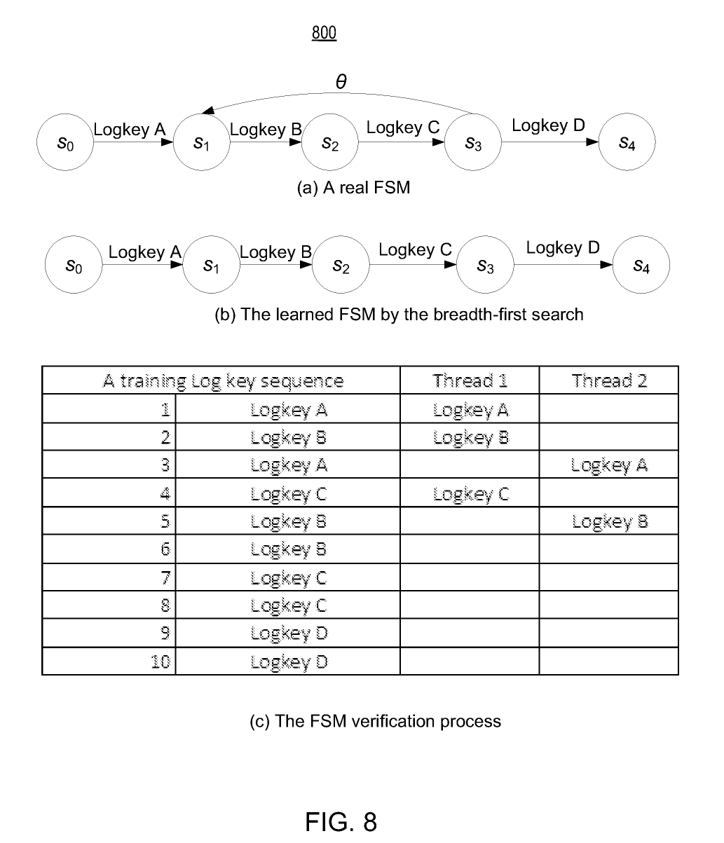

At step 350, the error detection application 60 may refine the initial FSM created in step 340. In one implementation, refining the initial FSM may identify loop structures and real short paths that may have been omitted in the initial FSM. For instance, many applications may contain loop structures, but the generated log key paths of the breadth-first search algorithm may not identify any loop structures because the temporal relationship information does not accurately identify the loop information. Additionally, the initial FSMs also do not contain any shortcuts because the pruning strategy described in step 340 removes all of the real short paths. In order to add loop structures and real short paths to the initial FSMs, the error detection application 60 may refine the initial FSMs through a verification process with the log key sequences extracted at step 310. An example of the refinement process is described in the paragraphs below with respect to FIG. 8.

Given the training log files generated by the multiple threads running the FSM of FIG. 8(a), the error detection application 60 may use the breadth-first search algorithm to construct a FSM without a loop as shown in FIG. 8(b). In FIG. 8(c), the first five log items of the training log sequence are generated by two threads running with the initial FSM. When the 6^{th} log item “Logkey B” is being verified, s₃ and s₂ are the current states of thread 1 and thread 2, respectively, and no thread can produce “Logkey B” from their current states. In one implementation, this situation indicates that the input sequence is generated by the original FSM with a loop structure and the 6^{th} log item “Logkey B” is a part of the recurrence. In general, for any training log sequence with a different interleaving pattern, when verifying the log item “Logkey B” or “Logkey C”, which is a part of the recurrence, there may be at least one thread whose current state is s₃. By counting the current states for all training sequences, the error detection application 60 may determine whether state s₃ has the highest occurrence rate. This information may then be used to detect the loop structures and to recover the missed shortcuts.

During the verification process, the error detection application 60 may not have any information about when a new thread starts. In this manner, a mismatched log item can be interpreted as a log produced by a missed FSM structure or a newly started thread. For example, the 6^{th} log item in FIG. 8(c) may also be understood as a log generated by a new thread running the FSM (FIG. 8(b)) with a new transition of δ(s₀,Logkey B)=s₂, and the thread starts from s₀ and ends at s₃. In fact, every mismatched log item can be interpreted as a log of a new thread. However, creating a new thread for each mismatched log item may not efficiently create an accurate FSM.

By using the verification process described above, the error detection application 60 may use the simplest FSM with minimal number of threads in order to interpret all of the training log sequences. In other words, if two FSMs can be used to interpret the training log, the error detection application 60 will prefer the FSM with fewer transitions. If two FSMs have the same number of transition edges, the error detection application 60 will prefer the FSM that interprets all training logs with minimal thread number. For each transition of FSM, the error detection application 60 may check whether it is used during the verification. The error detection application 60 may remove the transitions that are not used during the verification process.

After identifying the loop structures and the shortcuts within the training log that may not be represented in the initial FSM, the error detection application 60 may modify the initial FSM to include the detected loop structures and shortcuts. In one implementation, the error detection application 60 may refine the FSM iteratively until the resulting FSM accurately describes the training log.

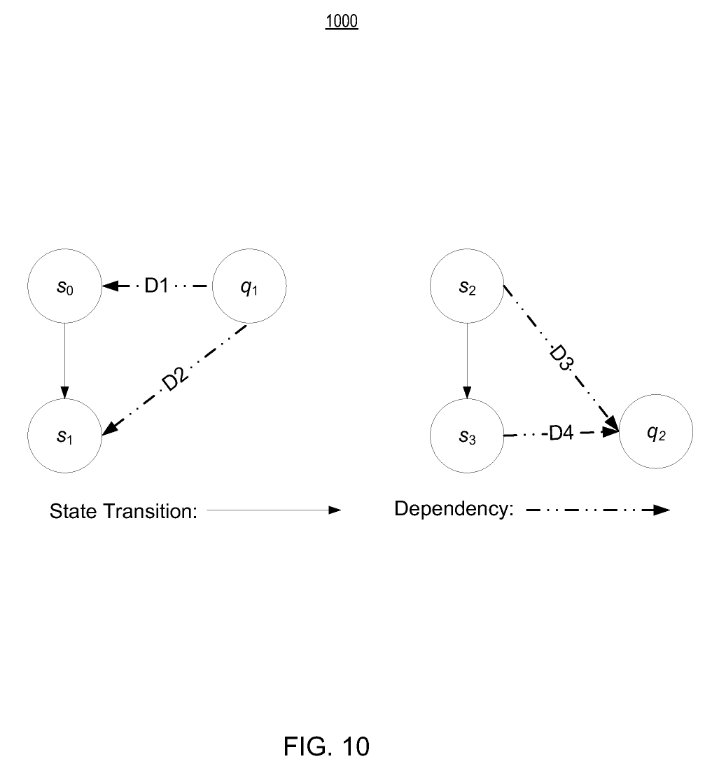

FIG. 9 illustrates a flow diagram of a method for creating a dependency graph in accordance with one or more implementations of various techniques described herein. The following description of flow diagram 900 is made with reference to computing system 100 of FIG. 1, the flow diagram 200 of FIG. 2, the flow diagram 300 of FIG. 3 and the example 1000 of FIG. 10. It should be understood that while the operational flow diagram 900 indicates a particular order of execution of the operations, in some implementations, certain portions of the operations might be executed in a different order. In one implementation, the method for creating the dependency graph may be performed by the error detection application 60.

At step 910, the error detection application 60 may perform a co-occurrence observation of the log keys in the log key sequence of the training log. In one implementation, the co-occurrence observation may determine whether the occurrence of one log key in the log key sequence depends on the occurrence of another log key. For example, if log key B depends on log key A, then log key B is likely to occur within a short time interval (e.g., dependency interval) after log key A occurred.

At step 920, the error detection application 60 may perform a correspondence observation. In one implementation, the correspondence observation may determine whether two log keys as listed in the training log contain at least one identical parameter. For most systems, two dependent log keys may often contain at least one identical parameter, such as a request ID. The identical parameter may be used by the error detection application 60 to track the execution flow of the training log. The error detection application 60 may then use the correspondence observation to identify dependent log keys.

At step 930, the error detection application 60 may perform a delay time observation. In one implementation, the delay time observation may be used to determine that a pair of log keys is dependent on each other when the delay time between the occurrences of each log key is consistent. Inconsistent delay times may indicate that the pair of log keys is not interdependent.

At step 940, the error detection application 60 may identify the dependent log keys in the training log using the co-occurrence, correspondence and delay time observations. In one implementation, the error detection application 60 may evaluate the co-occurrence and the correspondence observations by calculating a conditional probability between a pair of log keys listed in the training log. If the conditional probability of the pair of log keys exceeds a pre-determined threshold, the error detection application 60 may designate the pair of log keys as interdependent. After performing the co-occurrence and correspondence observations, the error detection application 60 may identify most of the interdependent log keys in the training log.

In one implementation, the error detection application 60 may use the refined FSM determined at step 350 in FIG. 3 to convert each log key sequence to a temporal sequence, in which each element l has a corresponding state S(l) and a time stamp T(l). The time stamp T(l) of element l may be defined by the time stamp T(l) of the log message when the refined FSM indicates that a transition from its previous state to the state S(l) has occurred or the occurrence time of element l. After determining the time stamp T(l) of element l, the error detection application 60 may obtain a set of training state sequences. The training state sequences may be obtained by applying the FSMs to convert a training log key sequence to a training state sequence. For example, in FIG. 4, a log key sequence “ABC” can be converted into a state sequence “s₀, s₁, s₂, s₄.”

In one implementation, for a log message m, the error detection application 60 may denote the extracted log key of the log message m as K(m), the number of parameters as PN(m), the i^{th} parameter's value as PV(m,i). After the log key and the parameters are extracted, the error detection application 60 may represent each log message m with a time stamp T(m) by a multi-tuple [T(m), K(m), PV(m,1),PV(m,2), . . . , PV(m,PN(m))]. Such multi-tuples may be referred to as tuple-form representations of the log messages.

The error detection application 60 may then merge all of the training state sequences of different system components into one single aggregated sequence (E). In this manner, the error detection application 60 may evaluate the co-occurrence of two log keys s and q and the correspondence of their parameters PV(s,d₁) and PV(q,d₂) based on the conditional probabilities P(Q|q) and P(Q|s). Here, Q represents the quadruple (s, d₁, q, d₂), P(Q|q) is the probability that log key s occurs within a dependency interval around the occurrence of q, and the d₁ parameter of s is equal to the d₂ parameter of q, and it can be estimated through the following equation:

$$P ( Q \vert s ) = \frac{{C}_{s} ( Q )}{O ( s )}$$

where O(s) is the number of all log messages whose log key is s, and Cₛ(Q) is the total number of log messages (i.e., denoted as A) in all log files that satisfy the following two rules: (1) K(A)=s; and (2) there exists at least a log message B satisfying that K(B)=q, |T(A)−T(B)|<τ_{d}, and PV(A,d₁)=PV(B,d₂). Here, τ_{d} is the dependency interval. For each log message in A, all such log messages B form a set, denoted as Ω(A,Q).

Similarly, P(Q|q) may also be estimated through the same procedure as described above. Based on the conditional co-occurrence probabilities, the error detection application 60 may identify each related log key pair by assuming that at least one conditional probability of the quadruple is higher than a threshold Th_{cp}, such that:

max_{d}_{₁}_{,d}_{₂}(P(s,d₁,q,d₂|s),P(s,d₁,q,d₂|q))≧Th_{cp}

In some implementations, calculating the conditional probabilities of each state pair in the FSM may be time consuming because calculating the conditional probabilities for each state pair may include calculating probabilities of functions having 4 variables (e.g., quadruples). For example, the co-occurrence of two states, s and q, and the correspondence of their parameters (PV(s,d₁) and PV(q,d₂)) may have conditional probabilities defined as P(s,d₁,q,d₂ q) and P(s,d₁,q,d₂ s). In this manner, if there are N log keys, and each log message has M parameters, there will be about N (N−1) M² quadruples. In order to improve the computational efficiency of the algorithm, the error detection application 60 may only estimate the above conditional probabilities for inter-component log key pairs because the inter-component dependencies are more relevant in the system management and fault localization.

To further reduce the computational cost, the error detection application 60 may evaluate the concurrency of two states s and q based on the conditional probabilities P(s|q) and P(q|s). Here, P(s|q) is the probability that state s occurs in a dependency interval around the occurrence of state q. Similarly, P(q|s) is the probability of state q's occurrence in a dependency interval around state s. The conditional concurrency probability of P(q|s) is estimated by the following equation:

$$P ( q \vert s ) = \frac{C [ s , q ]}{O [ s ]}$$

where O[s] records the number of elements in the aggregated sequence E with its state being state s, and C[s,q] denotes the number of elements 1 in the aggregated sequence E that satisfy the following two rules: (1) S(l)=s; and (2) there exists at least one element l′ satisfying |T(l)−T(l′)|<τ_{d} and S(l′)=q (where τ_{d} is the dependency interval). In one implementation, if both (s|q)<Th_{cp} and P(q|s)<Th_{cp} are true, the error detection application 60 may not need to calculate the conditional probabilities of all log key pairs.

In some implementations, a heartbeat or routine check message that may occur periodically in the program may also be recorded as log messages in the training log. In this manner, the process described in step 940 may result in some false positive dependencies. For example, if state s is a state related to a heart beat log with a high frequency, P(s|q) will always have a large value for any state q no matter whether state and state q have a dependency relationship. The error detection application 60 may use the correspondence observation as described in step 910 to remove the false positive dependencies caused by heart beat log messages (i.e., long-running periodic log messages).

At step 950, the error detection application 60 may determine the direction of dependent log keys identified in step 940. For a related state pair, in general, the state with a later time stamp often depends on the state with an earlier time stamp. However, because log files are usually printed at different machines, the time stamps of log messages are recorded as the local time of their machines, which are often not precisely synchronized. As such, determining the real occurrence order of states becomes a difficult task. In one implementation, the error detection application 60 may overcome this problem and determine the direction in which a pair of states is related using the Bayesian decision theory.

For example, given a related state pair (s,q), the error detection application 60 may find n samples of the pair from the training log files (sᵢ,qᵢ), i=1 . . . n, and their corresponding time stamp pairs (tₛ_{ᵢ}, t_{q}_{ᵢ}), i=1 . . . n. Because the log time stamps tₛ_{ᵢ} and t_{q}_{ᵢ} are recorded as local time, the error detection application 60 may use the following equation to represent the actual time stamps:

tₛ_{ᵢ}=\hat{t}ₛ_{ᵢ}+δₛ_{_{i and}} t_{q}_{ᵢ}=\hat{t}_{q}_{ᵢ}+δ_{q}_{ᵢ}

where \hat{t}ₛ_{ᵢ} and \hat{t}_{q}_{ᵢ} are the absolute occurrence time of sᵢ and qᵢ respectively, and δₛ_{ᵢ} and δ_{q}_{ᵢ} are the time alignment errors respectively. Therefore,

$$\frac{{\sum }_{i = 1}^{n} ( {t}_{si} - {t}_{qi} )}{n} = \frac{{\sum }_{i = 1}^{n} ( {\hat{t}}_{si} - {\hat{t}}_{qi} )}{n} + \frac{{\sum }_{i = 1}^{n} {δ}_{si} - {\sum }_{i = 1}^{n} {δ}_{qi}}{n}$$

Let δₛ_{ᵢ} and δ_{q}_{ᵢ} (i=1 . . . n) be independent and identically distributed random errors with E(δ)=μ and var(δ)=σ². Denoting

$$\frac{{\sum }_{i = 1}^{n} ( {t}_{si} - {t}_{qi} )}{n} = {μ}_{sq} and \frac{{\sum }_{i = 1}^{n} ( {\hat{t}}_{si} - {\hat{t}}_{qi} )}{n} = {\hat{T}}_{sq} ,$$

the error detection application 60 may find that \hat{T}_{sq} asymptotically complies with a normal distribution with a mean of μ_{sq} and a variance of

$$\frac{2 {σ}^{2}}{n}$$

if the error detection application 60 has enough training log sequences. Based on the Bayesian decision theory, the error detection application 60 may then determine the dependency direction as follows:

μ_{sq}>β→\hat{T}_{sq}>0→s depends on q

or

μ_{sq}<−β→\hat{T}_{sq}<0→q depends on s

The error detection application 60 may use a threshold β to control the confidence of the decision. In one implementation, the error detection application 60 may set β=0.005 seconds and select sample element pairs, denoted as (l₁,l₂), for the direction determination, which satisfy:

$${l}_{2} = {argmin}_{l ∈ \{ \vert T ( l ) - T ( {l}_{1} ) \vert < {τ}_{d} \}} ( \vert T ( l ) - T ( {l}_{1} ) \vert )$$

$$and$$

$${l}_{1} = {argmin}_{l ∈ \{ \vert T ( l ) - T ( {l}_{2} ) \vert < {τ}_{d} \}} ( \vert T ( l ) - T ( {l}_{2} ) \vert )$$

In other words, the elements of the pair are the ones temporally closest to each other in the dependency interval. In some implementations, the error detection application 60 may employ this strategy to remove mismatched element pairs because the related states are assumed to be temporally close with each other. In this manner, the error detection application 60 may improve the accuracy of the estimated directions.

At step 960, the error detection application 60 may create the dependency graph (DG) using the identified dependent log keys obtained in step 940 and the dependency direction of the identified log keys obtained in step 950. The DG may be used to locate the root error or where an error began in a new log. This process will be described in greater detail in the paragraphs below with reference to FIG. 11.

In one implementation, while creating the DG, the error detection application 60 may identify dependent state pairs by determining the concurrency of the states. Many redundant dependent state pairs may be found based on a concurrency algorithm. For example, in FIG. 10, if state s₀ transitions to state s₁ in a very short time period, the error detection application 60 may identify two dependencies, D₁ and D₂, simultaneously. Similarly, other dependencies (i.e., D₃ and D₄) may also be found using the concurrency algorithm. In one implementation, dependency D₂ and dependency D₃ may be defined as redundant dependencies in these two cases because they can be inferred from dependency D₁ and dependency D₄, respectively. In order to obtain a simple and clear dependency graph, the error detection application 60 may carry out a pruning operation such that the redundant dependencies or the redundant dependency edges (e.g., dependencies D₁ and D₄) may be removed from the DG.

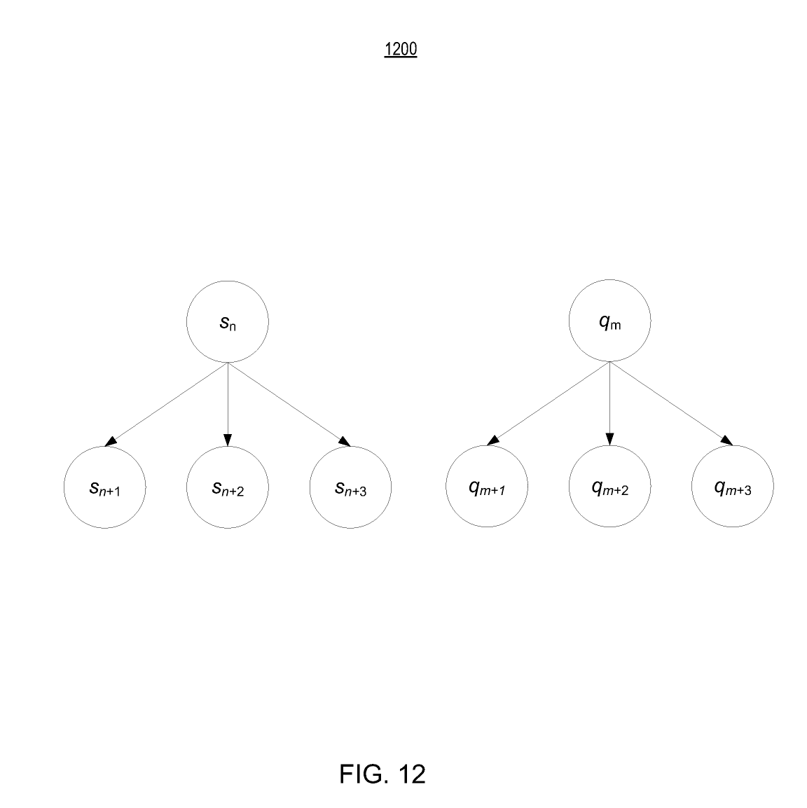

FIG. 11 illustrates a flow diagram of a method for determining a root error in accordance with one or more implementations of various techniques described herein. The following description of flow diagram 1100 is made with reference to computing system 100 of FIG. 1, the flow diagram 200 of FIG. 2, the flow diagram 300 of FIG. 3 and the example 1200 of FIG. 12. It should be understood that while the operational flow diagram 1100 indicates a particular order of execution of the operations, in some implementations, certain portions of the operations might be executed in a different order. In one implementation, the method for determining the root error may be performed by the error detection application 60.

In one implementation, the error detection application 60 may determine whether a new log sequence of a component is acceptable by its FSM. If the new log sequence can be generated by the FSM, then the error detection application 60 may determine that no anomaly occurs. If, however, only a part of a new log key sequence, can be generated by the FSM, the error detection application 60 may consider the new log key sequence to be abnormal. In one implementation, the error detection application 60 may designate an abnormal or anomalous pattern in the new log sequence as an error in the execution of the system. Accordingly, the error detection application 60 may determine that the first log key item that cannot be generated by the FSM is an error position in the component. In one implementation, the error detection process described in FIG. 11 may be performed for all system components independently and simultaneously by the error detection application 60.

At step 1110, the error detection application 60 may extract a new log key sequence from the new log received at step 240. In one implementation, extracting the new log key sequences may include a similar process as described in step 310 of FIG. 3 using the new log.

At step 1120, the error detection application 60 may attempt to generate each new log key sequence obtained in step 1110 using the FSM created at step 350 in FIG. 3.

At step 1130, the error detection application 60 may encounter a new log key item in the new log key sequence that may not exist in the FSM. The error detection application 60 may denote the new log key items that may not exist in the FSM as error positions in the new log. In one implementation, the error detection application 60 may detect error positions for all system components from their corresponding logs. In many distributed systems, an error occurring at one component may often cause execution anomalies of other components due to the inter-component dependencies.

At step 1140, the error detection application 60 may identify or group related error positions. In one implementation, the error detection application 60 may determine whether the error positions from different components are related using the following two rules. The first rule is to identify related error positions when the time difference between the occurrences of two error positions is less than a predetermined threshold. The second rule is to identify related error positions when there is a dependency between two inaccessible states of the two errors. In one implementation, inaccessible states may refer to state transitions in the new log that cannot occur according to the FSM.

In some implementations, an error may have a few different inaccessible states because the FSM has multiple branches starting from a particular state. For example, in FIG. 12, both state sₙ and state qₘ have three possible consequent states. Given two errors occurring immediately after state sₙ and state qₘ, respectively, there are at most 9 potential dependency state pairs: Dependency(sₙ₊ᵢ,qₘ₊ⱼ), i,j=1, 2, 3. To determine the related error positions, the error detection application 60 may evaluate the following probabilities P(Dep(sₙ₊ᵢ,qₘ₊ⱼ)) for each potential dependency candidate:

P(Dep(sₙ₊ᵢ,qₘ₊ⱼ))=P(sₙ→sₙ₊ᵢ)·P(qₘ→qₘ₊ⱼ)·max(P(sₙ₊ᵢ|qₘ₊ⱼ),P(qₘ₊ⱼ|sₙ₊ᵢ))

where P(sₙ→sₙ₊ᵢ) is the probability that state sₙ transitions to state sₙ₊ᵢ in the training data set, and P(qₘ→qₘ₊ⱼ) is the probability that state qₘ transitions to state qₘ₊ⱼ. The error detection application 60 may determine that only the transitions with the highest probabilities P (Dep(sₙ₊ᵢ,qₘ₊ⱼ)) will be considered as related error positions.

At step 1150, the error detection application 60 may then use the DG to trace the dependencies of the identified related error positions and locate the root error of the related errors. By using the DG, the error detection application 60 may locate the identified related error positions and continuously identify the inter-error dependencies until the root error is found. In one implementation, the error detection application 60 may also create an error propagation path among the program components. The error propagation path may describe how an error of a system component may cause an error in another system component.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computerized method for automatically locating a root error, comprising:
receiving a first log having one or more log messages produced by one or more successful runs of a program;
creating a finite state machine (FSM) from the first log of the program, the FSM representing an expected workflow of the program;
creating a graph from the first log, the graph illustrating one or more dependencies between two or more components in the program;
receiving a second log produced by an unsuccessful run of the program; and
determining, using a microprocessor, one or more root errors in the second log using the FSM and the graph.

2. The method of claim 1, wherein creating the FSM comprises:
extracting one or more log keys and one or more parameters from the log messages, wherein the log keys represent one or more meanings of the log messages and the parameters represent one or more attributes of the log messages;
converting the log keys into a log key sequence according to an order in which the corresponding log messages appeared in the first log;
determining one or more temporal relationships between the log keys in the log key sequence;
creating the FSM based the temporal relationships; and
refining the FSM based the first log.

3. The method of claim 2, wherein determining the temporal relationships comprises:
creating one or more forward labels for each item in the log key sequence;
creating one or more backward labels for each item in the log key sequence; and
determining the temporal relationships between each item in the log key sequence based on the forward labels and the backward labels.

4. The method of claim 2, wherein creating the FSM comprises using a breadth-first search algorithm to identify one or more paths in the FSM.

5. The method of claim 2, wherein refining the FSM comprises:
generating the log key sequence using the FSM;
identifying one or more loop structures missing in the FSM according to the first log;
identifying one or more paths missing in the FSM according to the first log; and
adding the loop structures and the paths to the FSM.

6. The method of claim 2, wherein the FSM is refined iteratively.

7. The method of claim 1, wherein the FSM is a behavior model of the program having a one or more states, one or more transitions between states and one or more actions between states.

8. The method of claim 1, wherein creating the graph comprises:
extracting one or more log keys and one or more parameters from the log messages, wherein the log keys represent one or more meanings of the log messages and the parameters represent one or more attributes of the log messages;
identifying two or more dependent log keys based on a co-occurrence observation, a correspondence observation, a delay time observation or combinations thereof;
determining one or more directions between the two or more dependent log keys; and
creating the graph based on the two or more dependent log keys and the directions between the two or more dependent log keys.

9. The method of claim 8, wherein the co-occurrence observation is obtained by:
calculating a probability of an occurrence of a second log key in the log keys based on an occurrence of a first log key of the log keys, wherein the first log key occurs within a time period around the occurrence of the second log key; and
determining that the second log key and the first log key are dependent log key when the probability is greater than a predetermined threshold.

10. The method of claim 8, wherein the correspondence observation is obtained by:
determining whether two or more of the log keys have at least one identical parameter; and
determining that the two or more of the log keys are dependent on each other if the two or more of the log keys have the at least one identical parameter.

11. The method of claim 8, wherein the delay time observation is obtained by:
determining whether a delay time between a pair of the log keys is consistent; and
determining that the pair of the log keys are dependent on each other if the delay time is consistent.

12. The method of claim 8, wherein the directions between the two or more dependent log keys are determined using Bayesian decision theory.

13. The method of claim 1, wherein determining the root errors in the second log comprises:
extracting one or more log keys and one or more parameters from one or more log messages in the second log;
converting the log keys into a log key sequence according to an order in which the corresponding log messages appeared in the second log;
identifying one or more error positions in the log key sequence using the FSM;
identifying two or more related error positions from the error positions; and
determining the root errors of the related error positions using the graph.

14. The method of claim 13, wherein identifying the error positions comprises:
generating the log key sequence using the FSM; and
identifying an error position when one of the log keys cannot be generated in the FSM.

15. The method of claim 13, wherein the related error positions are identified when a time difference between the error positions is less than a predetermined threshold, when the error positions share a dependency with one or more inaccessible states in the FSM, or combinations thereof.

16. A computer-readable storage medium having stored thereon computer-executable instructions which, when executed by a computer, cause the computer to:
receive a first log having one or more log messages produced by one or more successful runs of a program;
extract one or more log keys and one or more parameters from the log messages, the log keys representing one or more meanings of the log messages and the parameters represent one or more attributes of the log messages;
create a finite state machine (FSM) from the log messages of the first log, the FSM representing an expected workflow of the program;
create a graph from the first log, the graph illustrating one or more dependencies between two or more components in the program;
receive a second log of produced by an unsuccessful run of the program; and
determine one or more root errors in the second log using the FSM and the graph.

17. The computer-readable storage medium of claim 16, wherein the graph is created by:
identifying two or more dependent log keys based on a co-occurrence observation, a correspondence observation, a delay time observation or combinations thereof;
determining one or more directions between the two or more dependent log keys; and
creating the graph based on the two or more dependent log keys and the directions between the two or more dependent log keys.

18. The computer-readable storage medium of claim 17, wherein the directions between the two or more dependent log keys are determined using Bayesian decision theory.

19. A computer system, comprising:
a processor; and
a memory comprising program instructions executable by the processor to:
receive a first log having one or more first log messages produced by one or more successful runs of a program;
create a finite state machine (FSM) from the first log of the program, the FSM representing an expected workflow of the program;
create a graph from the first log, the graph illustrating one or more dependencies between two or more components in the program;
receive a second log produced by an unsuccessful run of the program; and
extract one or more log keys and one or more parameters from one or more second log messages in the second log;
convert the log keys into a log key sequence according to an order in which the corresponding second log messages appeared in the second log;
identify one or more error positions in the log key sequence using the FSM;
identify two or more related error positions from the error positions; and
determine one or more root errors of the related error positions using the graph.

20. The computer system of claim 19, wherein the FSM is a behavior model of the program having a one or more states, one or more transitions between states and one or more actions between states.
